(19) United States
(12) Patent Application Publication
(10) Pub. No.: US 2009/0064067 A1
(43) Pub. Date: Mar. 5, 2009

(54) METHOD OF BALANCING PATH DELAY OF CLOCK TREE IN INTEGRATED CIRCUIT (IC) LAYOUT

(75) Inventors: Tsung-hsin Liu, Tainan City (TW); Li-yi Lin, Sioushuei Township (TW)

Correspondence Address: AUSTIN RAPP & HARDMAN, 15 WEST SOUTH TEMPLE, SUITE 900, SALT LAKE CITY, UT, 84101, US

(73) Assignee: Silicon Integrated Systems Corp., Hsin-Chu (TW)

(21) Appl. No.: 11/846,344

(22) Filed: Aug. 28, 2007

(51) Int. Cl. G06F 17/50

(52) U.S. Cl. 716/6; 716/18

(57) ABSTRACT

A method of balancing the path delay of a clock tree for minimizing clock skew of the clock tree in the IC layouts is described. The method includes the following steps: (a) A design tool calculates a plurality of path delay values from the root cell to each sink via some of the inverters, wherein the maximum one of the path delay values recorded on the sinks serves as a target value, respectively; (b) The design tool compares the path delay value of each sink with the delay value of the adjacent sink from each sink to the root cell for recording the compared higher value on each inverter until the higher compared values are recorded, respectively, in the inverters and the root cell; (c) The design tool compares the path delay value on each inverter with the target value from the root cell to the sinks to determine whether to change the cell type of the inverter from a current cell type to a new cell type by selecting the new cell type from the type database; (d) The design tool adds the difference value to the original value for updating the original value recorded in this inverter; and (e) The design tool adds the difference value to the values recorded on the downstream inverters relative to the inverter for repeatedly updating the values recorded on the downstream inverters and sinks to minimize the clock skew of the clock tree.

### FIELD OF THE INVENTION

The present invention relates to a method of designing integrated circuit (IC) layouts, and more particularly to a method of balancing path delay of clock tree in the IC layouts to effectively minimize the clock skew of the clock tree.

### BACKGROUND OF THE INVENTION

In digital system, clock signal is an important kind of control signal which synchronizes the data flow in the paths of a clock tree. To achieve the higher performance, the clock must be balanced to ensure that each clock signal arrives at all destinations (or “sinks”), such as registers and flip-flops, at the same time by minimizing the arrival time, so-called “clock skew”, at the destinations for destination-to-destination in order to meet the clock requirement.

However, it's hard to meet the requirement in clock tree synthesis (CTS) procedure, especially in a high speed digital system. Even if the clock skew meets the requirement after the CTS tool performs the CTS procedure, the performed result, e.g. the clock skew, will worsen dramatically after the physical synthesis tool executes the detailed routing for the nets of the clock tree and the other signal nets. Due to the difference between routing patterns and coupling capacitance issues, the path delay on each clock path in the clock tree becomes more unpredictable and the clock skew is hard to be minimized or fixed. Consequentially, there is a need to develop a novel method to solve the aforementioned problem.

### SUMMARY OF THE INVENTION

The first objective of the present invention is to provide a method of balancing the path delay of a clock tree in IC layouts to effectively minimize the clock skew by adjusting the cell type of the cell on the clock tree.

The second objective of the present invention is to provide a method of balancing the path delay of a clock tree in the IC layouts to keep the result of placement and the detailed routing after performing CTS procedure.

According to the above objectives, the present invention sets forth a method of balancing the path delay of the clock tree for minimizing clock skew of the clock tree. The method includes the following steps:

(a) A CTS tool establishes the clock tree;

(b) A design tool calculates a plurality of path delay values from the root cell to each sink via some of the inverters, wherein the maximum one of the path delay values recorded on the sinks serves as a target value, respectively;

(c) The design tool compares the path delay value of each sink with the delay value of the adjacent sink from each sink to the root cell for recording the compared higher value on each inverter until the higher compared values are recorded, respectively, in the inverters and the root cell;

(d) The design tool compares the path delay value on each inverter with the target value from the root cell to the sinks to determine whether to change the cell type of the inverter from a current cell type to a new cell type by selecting the new cell type from the type database. Each cell delay of the downstream inverters and sinks maintains invariant during the step of comparing the path delay value on each inverter with the target value;

(e) During the step of comparing the path delay value on each inverter with the target value, if the path delay value on the inverter is less than the target value, the cell type of the inverter is changed from the current cell type to the new cell type;

(f) The design tool re-calculates the cell delay of the inverter having the new cell type;

(g) The design tool adds the difference value, between the new cell delay and the original cell delay of the inverter, to the original value for updating the original value recorded in this inverter. If the updated value recorded on the inverter is equal to or approximate to the target value, this cell type change of the inverter is acceptable. Conversely, if the updated value exceeds the target value, this cell type change of the inverter is discarded and the original cell type of the inverter is still employed. When the cell type of the inverter is changed, the design tool adds the difference value to the value recorded on the downstream inverters in the sub-tree;

(h) The design tool adds the difference value to the values recorded on the downstream inverters relative to the inverter for repeatedly updating the values recorded on the downstream inverters and sinks to minimize the clock skew of the clock tree; and

(i) During the step of comparing the path delay value on each inverter with the target value, if the path delay value on the inverter is greater than the target value, the design tool utilizes the current cell type and return to step (d) to compare the next inverter with the target value.

In the present invention, the design tool allows the path delay value recorded on the inverters and the sinks to be approached to one another. The lower path delay values on the inverters are adjusted, respectively, to approach a target value. In one embodiment, the design tool adjusts the path delay value by changing the cell delay of the inverter, e.g. increasing the cell delay. For example, the design tool selects the zero output loading to be assigned to the initial cell type during the CTS procedure. After the CTS and routing procedures, the present invention changes the cell type to adjust the cell delay by increasing the output loading so that the path delay value recorded on the inverter is equal to or approximate to the target value. Even if the cell type is changed, the design tool keeps the result of placement and the detailed routing invariant.

The CTS tool balances the all path delays in clock tree by inserting addition cells, e.g. inverter or buffer, among the root cell and sinks in the clock tree to adjust the path delays within the branches to ensure that the clock tree will deliver each clock signal to every destination at nearly the same time.

After the CTS tool accomplishes the CTS procedure to generate the clock tree, the design tool enters the routing stage of all signal nets. Then, the design tool computes the clock skew of the clock tree once more and the computed result may be worse than the result during the CTS procedure because the path delays of each branch of the clock tree relatively become higher or lower, thereby downgrading the clock skew. Advantageously, the present invention changes the cell types of the inverters to refine the clock skew after performing CTS and routing procedures without altering cell placement or routing. That is, the cell type can be adjusted to improve the clock skew to meet the clock specification and the result of the cell placement and cell routing remain invariant.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic diagram of a clock tree established by a CTS tool according to one embodiment of the present invention;

FIG. 2 is a schematic view of clock tree when the design tool compares the path delay values with the adjacent delay values and sequentially records the maximum values on the inverters in the different levels according to one embodiment of the present invention;

FIGS. 3A-3C is a schematic view of the clock tree when the design tool compares each value recorded in the inverters at different levels with the target value according to one embodiment of the present invention; and

FIG. 4 is a flow chart of balancing path delay of clock tree in integrated circuit (IC) layout according to one embodiment of the present invention.

### DETAILED DESCRIPTION OF THE PREFERRED EMBODIMENTS

The present invention is directed to a method of balancing the path delay of a clock tree in the IC layouts to effectively minimize the clock skew by adjusting the cell type of the cell on the clock tree. Furthermore, the present invention provides a method of balancing the path delay of a clock tree in the IC layouts in order to keep the result of placement and the detailed routing after the CTS tool performs the CTS procedure.

During the CTS procedure and the following routing procedure, each cell, e.g. inverter, among the root cell and the sinks has the same area, input capacitance, and output loading. Thereafter, when a design tool performs the present method of balancing the path delay in the clock tree, each inverter among the root cell and the sinks has the same area and input capacitance, but some of the inverters preferably have different output loadings, respectively. For example, during the CTS and routing procedures, the design tool selects one or more inverters without output loading, i.e. zero output loading. However, if performing the present invention, the design tool selects new cell types from a type database and replaces the original cell types with the selected cell types for updating the cell delay of the inverters in the clock tree using the new cell types. It is noted that these various cell types have the different output loading and the cell type is associated with the cell delay. Preferably, the cell delay of the inverter is substantially proportional to the output loading.

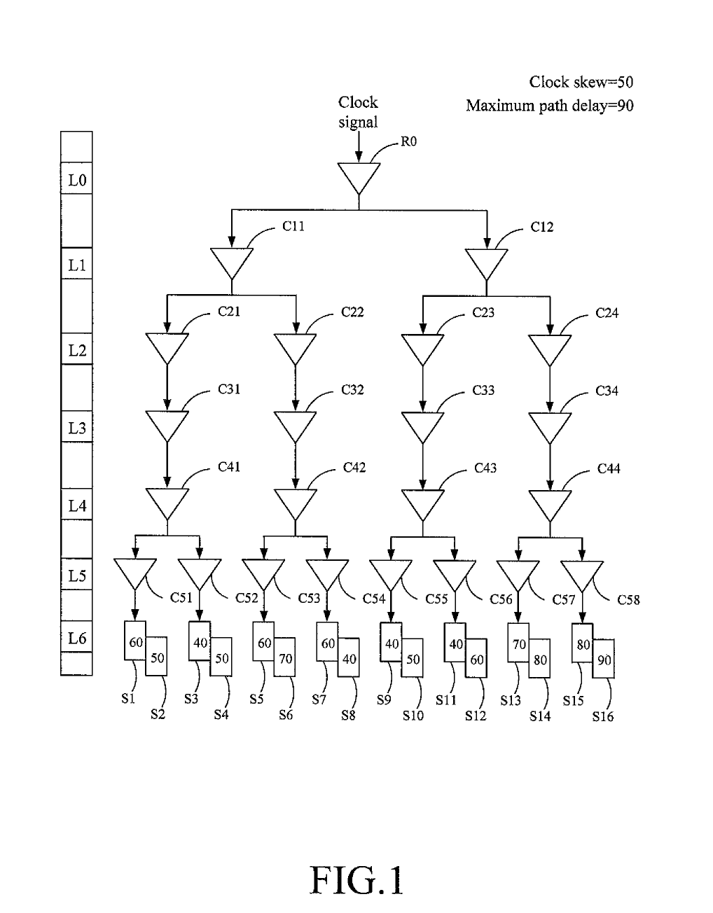

FIG. 1 is a schematic diagram of the clock tree established by a CTS tool according to one embodiment of the present invention. The CTS tool establishes the clock tree. The clock tree includes a root cell, a plurality of clock inverters, a plurality of sinks, and a plurality of signal nets among the root cell, the clock inverters and the sinks. The root cell is denoted as R0, the clock inverters are denoted as C1, C12, C21, C22, C23, C24, C31, C32, C33, C34, C41, C42, C43, C44, C51, C52, C53, C54, C55, C56, C57 and C58, respectively, and the sinks are denoted as S1 through S16, respectively. The root cell receives a clock signal and transmits the clock signal downstream to the sinks (S1 through S16) via the inverters (C11 through C58). The root cell R0 is located in level L0, the clock inverters C11 and C12 are located in level L1, the clock inverters C21, C22, C23, and C24 are located in level L2, the clock inverters C31, C32, C33, and C34 are located in level L3, the clock inverters C41, C42, C43, and C44 are located in level L4, and the clock inverters C51, C52, C53, C54, C55, C56, C57 and C58 are located in level L5. The sinks S1 through S16 are located in level L6.

The CTS tool calculates the path delays from the root cell R0 to each sink (S1 through S16), respectively. Preferably, the path delays are calculated according to SDF file produced by static timing analysis (STA) tool and each path delay is recorded within each sink (S1 through S16), respectively. Each path delay corresponding to the each sink (S1 through S16) represents the delay value from the root cell R0 to each sink (S1 through S16) via some of the inverters (C11 through C58) in the clock tree. For example, the path delay values of the sinks S1 through S16 are the sink S1 (60), the sink S2 (50), the sink S3 (40), the sink S4 (50), the sink S5 (60), the sink S6 (70), the sink S7 (60), the sink S8 (40), the sink S9 (40), the sink S10 (40), the sink S11 (40), the sink S12 (60), the sink S13 (70), the sink S14 (80), the sink S15 (80), and the sink S16 (90), respectively, wherein the units of the path delay values shown in the parentheses are preferably measured by a time unit. The clock skew is defined as the difference between the maximum path delay and the minimum path delay. In this case, the clock skew is 50, i.e. the path delay difference value between the sink S16 (90) and one of the sink S3 (40), the sink S8 (40), the sink S9 (40) and the sink S11 (40).

In one embodiment, the present invention also specifies the maximum path delay, 90, of the sink, as shown in S16, as a target value.

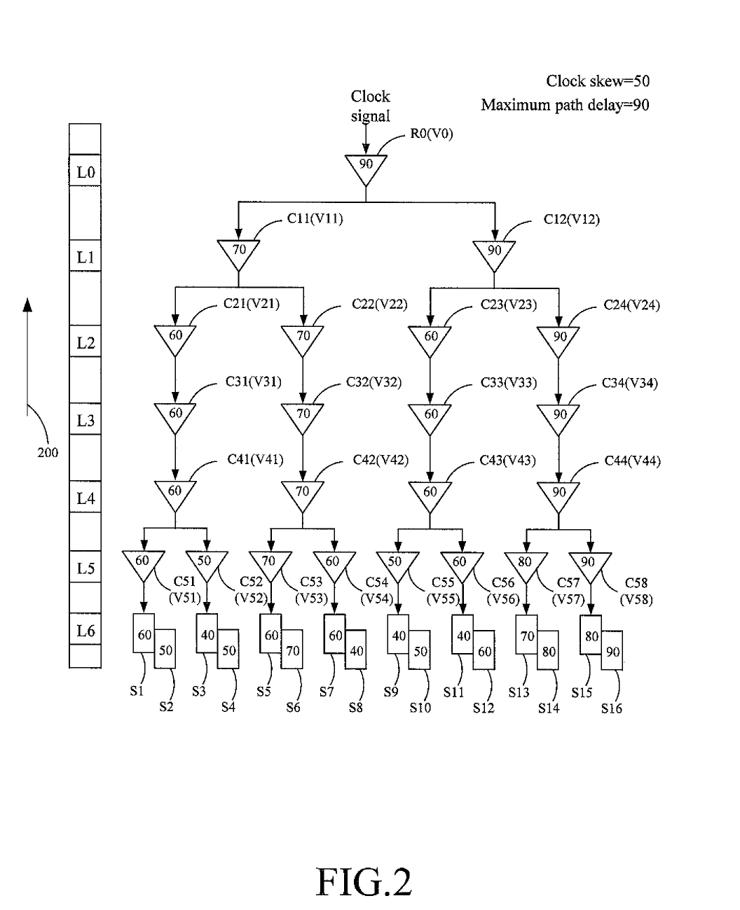

Please refer to FIG. 1 and FIG. 2 which depicts a schematic view of the clock tree when the design tool compares the path delay values with the adjacent delay values and sequentially records the maximum values on the inverters in the different levels according to one embodiment of the present invention. From bottom level L6 to the previous level L5, the design tool compares the path delay values of the sinks with the delay values of the adjacent sinks and records the maximum values on the inverters in the previous level L5. Next, the design tool compares the delay value, recorded on the inverter, with the delay value, recorded on the adjacent inverters, in the level L5 until the compared maximum values are sequentially recorded on all the inverters from the level L5 to level L1, as shown in an arrow line 200. Finally, the design tool selects one of the maximum values recorded on the inverters in the level L1 and record the maximum value on the root cell R0 in the level L0.

The values recorded on the clock inverters C11, C12, C21, C22, C23, C24, C31, C32, C33, C34, C41, C42, C43, C44, C51, C52, C53, C54, C55, C56, C57 and C58 are denoted as V11, V12, V21, V22, V23, V24, V31, V32, V33, V34, V41, V42, V43, V44, V51, V52, V53, V54, V55, V56, V57 and V58, respectively, from the level L5 to level L1, and the value recorded on the root cell R0 in the level L0 is denoted as V0. Each value (V11 through V58, and V0) is recorded on each clock inverter (C11 through C58) and the root cell R0, respectively, and represents the maximum path delay value among the paths through the inverters (C11 through C58) and the root cell R0. That is, both the path from the root cell R0 to the sink S1 and the path from the root cell R0 to the sink S2 pass through the inverter C51 in the level L5, and the maximum path delay value, i.e. the higher value between the sinks S1 and S2 in the level L6, between the paths is selected and recorded on the inverter C51. Similarly, the paths from the root cell R0 to the sinks S1 and S2 via the inverter C51 and the paths from the root cell R0 to the sinks S3 and S4 via the inverter C52 pass through the inverter C41 in the level L4, and the maximum path delay value, i.e. the higher value between the inverters C51 and C52 in the level L5, among the paths is selected and recorded on the inverter C41. The rest may be inferred by analogy. The paths from the root cell R0 to the sinks S1 through S8 via the inverters C11, C21, C22, C31, C32, C41, C42, C51, C52, C53, and C54, and the paths from the root cell R0 to the sinks S9 through S16 via the inverters C12, C23, C24, C33, C34, C43, C44, C55, C56, C57, and C58 pass through the root cell R0 in the level L0, and the maximum path delay value, i.e. the higher value between the inverters C11 and C12 in the level L1, among the paths is selected and recorded on the root cell R0.

For example, the design tool compares the sink S1 (60) with the sink S2 (50) and assigns the higher value, i.e. sink S1 (60), to the inverter C51. Thus, the value 60 is the maximum path delay value among the paths that will pass through the inverter C51 and the value 60 is recorded on the inverter C51. Similarly, the sinks S3 through S16 are compared with each other and the higher compared values are recorded on the inverters (C52 through C58) in the level L5. The rest of the inverters may be inferred by analog until the design tool compares the inverter C11 (70) with the inverter C12 (90) in the level L1 to generate a value, 90, of the root cell R0 in the level L0. The compared value 90 (V0) recorded on the root cell R0 is the maximum path delay value among the path through the root cell R0 in the clock tree.

Generally, the path delay includes cell delay and net delay. The cell delay mainly depends on the cell type and the output loading of the cell and the net delay is invariant if the size and placement of the cell in the clock tree has no change.

According to the above-mentioned descriptions, the design tool compares the each path delay value with the adjacent delay value therebetween and sequentially records the higher value on the inverter in the different levels in order to indicate the status of the inverters related to the path delay.

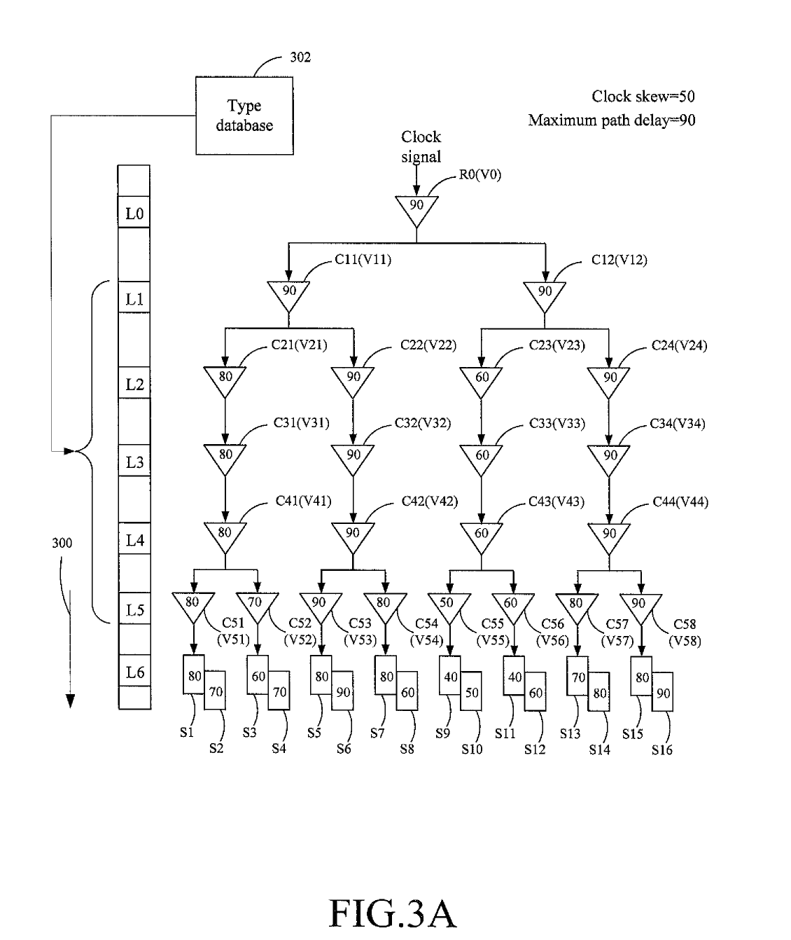

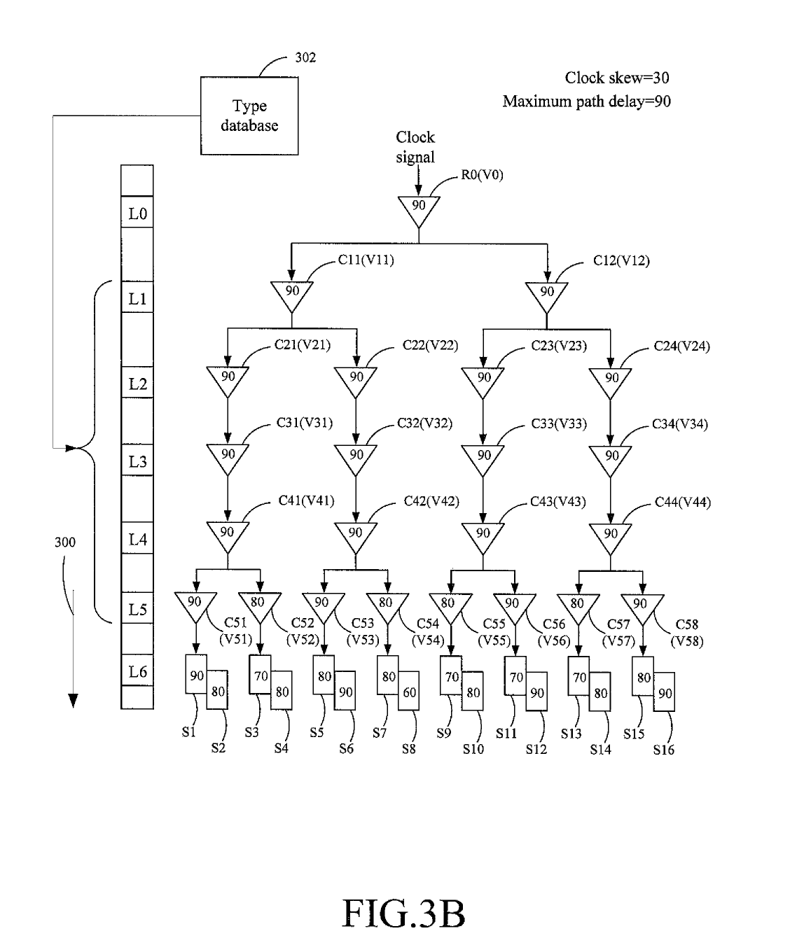

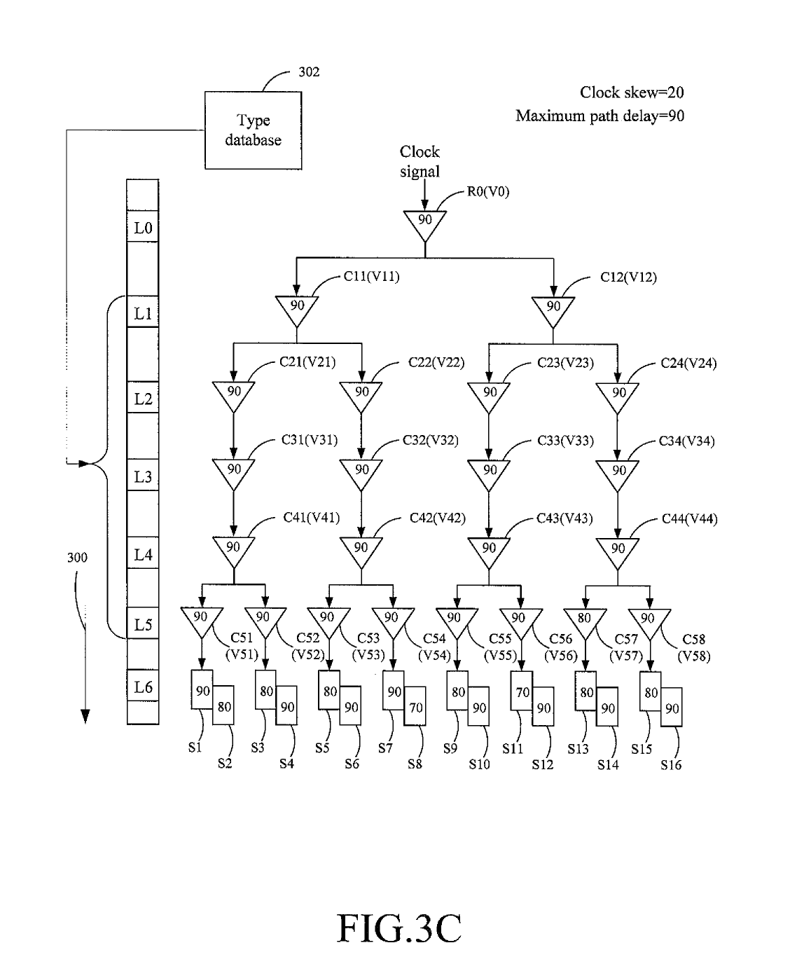

As shown in FIG. 2, the design tool finds a maximum value, i.e. value 90 recorded on the sink S16, among the values recorded on the sinks and sets the found maximum value as a target value. From the level L1 to bottom level L5, as shown in an arrow line 300, the design tool then compares each value recorded in the inverters (C11 through C58) at each level (L1 through L5) with the target value, as shown in FIGS. 3A-3C.

FIG. 3A is a schematic view of the clock tree when the design tool compares each value recorded in the inverters at level L1 with the target value according to one embodiment of the present invention. If the value recorded in one inverter is less than the target value, the design tool changes the cell type of the inverter from one current cell type to one new cell type by selecting the new cell type from a type database 302. Then, the design tool re-calculates the cell delay of the inverter having the new cell type and adds the difference value (termed as “D_{diff}”), between the new cell delay and the original cell delay of the inverter, to the original value for updating the original value recorded in this inverter. If the updated value recorded on the inverter is equal to or approximate to the target value, this cell type change of the inverter is acceptable. Conversely, if the updated value exceeds the target value, this cell type change of the inverter is discarded and the original cell type of the inverter is still employed. When the cell type of the inverter is changed, the design tool adds the difference value (D_{diff}) to the value recorded on the downstream inverters in the sub-tree. In the present invention, the cell type change of the inverter on the upstream exerts the effect, e.g. the difference value of the path delay, on the downstream inverters. Further, each cell delay of the downstream inverters and sinks in the sub-tree preferably maintains invariant based on the transmission direction of the clock signal while the cell type of the upstream inverter is changed.

For example, referring to FIG. 2 and FIG. 3A, the value recorded in the inverter C11 is 70 in the level L1 and the target value is 90. Because the value in the inverter C11 (70) is less than the target value, 90, the design tool changes the cell type of the inverter C11 by selecting the new cell type from the type database 302. The design tool then re-calculates the cell delay of the inverter C11 having the new cell type and adds the difference value, i.e. value 20, between the new cell delay and the original cell delay of the inverter C11 to the original value C11 (70) for updating the original value, e.g. value 70, in this inverter C11 to be value 90. The cell type change of the inverter C11 on the upstream exerts the difference value on the downstream inverters C21, C22, C31, C32, C41, C42, C51, C52, C53, C54 and the sinks S1 through S8. Further, each cell delay of the downstream C21, C22, C31, C32, C41, C42, C51, C52, C53, C54 and the sinks S1 through S8 in the sub-tree preferably maintains invariant while the cell type of the upstream inverter C11 is changed. The new cell type is assigned to the inverter C11 and the updated value, i.e. value 90, is equal to the target value. Since the cell type of the inverter C11 is changed, the design tool adds the difference value 20 to the downstream inverters, i.e. the inverters C21, C22, C31, C32, C41, C42, C51, C52, C53, C54 and the sinks S1 through S8, based on the inverter C11 in the sub-tree, for updating the values recorded on the downstream inverters and sinks, respectively.

FIG. 3B is a schematic view of the clock tree when the design tool compares each value recorded in the inverters at level L2 with the target value according to one embodiment of the present invention. Similar to FIG. 3A, the design tool finds the values recorded on the inverter C21 (80) and the inverter C23 (60) in the level L2 and the target value is 90. Because the value in the inverter C21 (80) less than the target value, 90, the design tool change the cell type of the inverter C21 by selecting the new cell type from the type database 302. In addition, since the value in the inverter C23 (60) also less than the target value, 90, the design tool changes the cell type of the inverter C23 by selecting the new cell type from the type database 302. Then, the design tool replaces the values recorded on these downstream inverters C31, C33, C41, C43, C51, C52, C55, C56, S1 through S4, and S9 through S12 in the sub-tree for updating the values recorded in the downstream inverters and the sinks therein.

FIG. 3C is a schematic view of the clock tree when the design tool compares each value recorded in the inverters at level L5 with the target value according to one embodiment of the present invention. Similar to FIG. 3B, the design tool finds the values recorded on the inverters C52 (90), C54 (90), C55 (90), and C57 (90) in the level L5 and the target value is 90. Because the values recorded on the inverters C52 (90), C54 (90), C55 (90), and C57 (90) are less than the target value, 90, the design tool changes, respectively, the cell type of the inverters C52, C54, C55, and C57 by selecting the new cell types from the type database 302. Then, the design tool replaces the values recorded on these downstream sinks S3, S4, S7 through S10, S13, and S14 in the sub-tree for updating the values recorded in the downstream sinks therein.

In the present invention, the design tool allows the path delay value recorded on the inverters and the sinks to be approached to one another. The lower path delay values on the inverters are adjusted, respectively, to approach a target value. In one embodiment, the design tool adjusts the path delay value by changing the cell delay of the inverter, e.g. increasing the cell delay. For example, the design tool selects the zero output loading to be assigned to the initial cell type during the CTS procedure. After the CTS and routing procedures, the present invention changes the cell type to adjust the cell delay by increasing the output loading so that the path delay value recorded on the inverter is equal to or approximate to the target value. Even if the cell type is changed, the design tool keeps the result of placement and the detailed routing invariant.

After the design tool changes the cell types of some inverters from the level L1 to bottom level L5, the design tool updates the verilog and design exchange format (DEF) file based on the result of the change of cell type. The new files are utilized to run STA procedure for new clock skew without detail routing or eco routing.

Based on the above description, the CTS tool inserts addition cells, e.g. inverter or buffer, between the root cell and the sinks in the clock tree during the CTS procedure for adjusting the path delays within the branches in order to ensure that the clock tree delivers each clock signal from the root cell to every destination at nearly the same time. That is, the clock skew of the clock tree is minimized. After the CTS tool accomplishes the CTS procedure for generating the clock tree, the design tool enters the routing stage of all signal nets. Then, the design tool computes the clock skew of the clock tree once more and the computed clock skew is worse than the result during the CTS procedure because the path delays of each branch of the clock tree relatively become higher or lower, thereby downgrading the clock skew. Advantageously, the present invention changes the cell types of the inverters to refine the clock skew after performing CTS and routing procedures without altering cell placement or routing. That is, the cell type can be adjusted for balancing path delay of clock tree to improve the clock skew to meet the clock requirement, and the result of the cell placement and cell routing remain invariant.

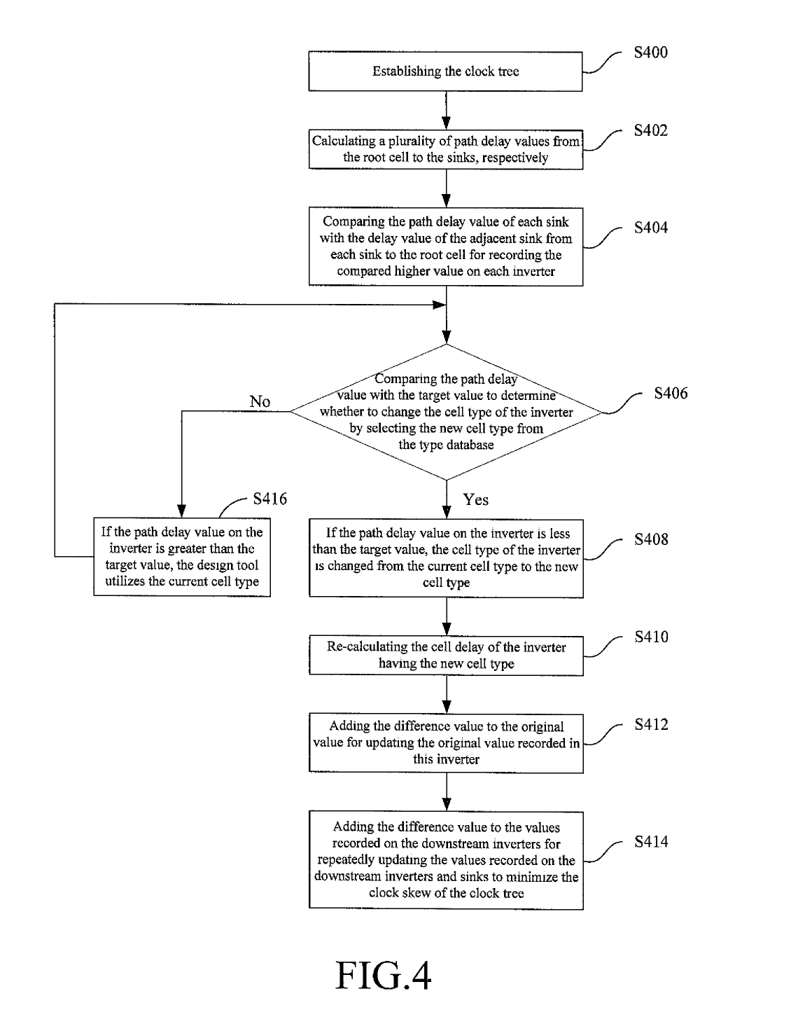

Please refer to FIGS. 2, 3A-3C, and FIG. 4 which depicts a flow chart of balancing path delay of clock tree for minimizing clock skew of the clock tree in the integrated circuit (IC) layouts according to one embodiment of the present invention. The method of balancing the path delay of a clock tree in the IC layout includes the following steps of:

In step S400, a CTS tool establishes the clock tree.

In step S402, a design tool calculates a plurality of path delay values from the root cell R0 to each sink (S1 through 516) via some of the inverters, wherein the maximum one of the path delay values recorded on the sinks serves as a target value, respectively.

In step S404, the design tool compares the path delay value of each sink (S1 through S16) with the delay value of the adjacent sink from each sink to the root cell R0 for recording the compared higher value on each inverter until the higher compared values are recorded, respectively, in the inverters (C11 through C58) and the root cell R0.

In step S406, the design tool compares the path delay value on each inverter with the target value from the root cell R0 to the sinks (S1 through S16) to determine whether to change the cell type of the inverter from a current cell type to a new cell type by selecting the new cell type from the type database 302. Each cell delay of the downstream inverters and sinks maintains invariant during the step of comparing the path delay value on each inverter with the target value.

In step S408, during the step of comparing the path delay value on each inverter with the target value, if the path delay value on the inverter is less than the target value, the cell type of the inverter is chanced from the current cell type to the new cell type.

In step S410, the design tool re-calculates the cell delay of the inverter having the new cell type.

In step S412, the design tool adds the difference value (D_{diff}), between the new cell delay and the original cell delay of the inverter, to the original value for updating the original value recorded in this inverter. If the updated value recorded on the inverter is equal to or approximate to the target value, this cell type change of the inverter is acceptable. Conversely, if the updated value exceeds the target value, this cell type change of the inverter is discarded and the original cell type of the inverter is still employed. When the cell type of the inverter is changed, the design tool adds the difference value (D_{diff}) to the value recorded on the downstream inverters in the sub-tree.

In step S414, the design tool adds the difference value to the values recorded on the downstream inverters relative to the inverter for repeatedly updating the values recorded on the downstream inverters and sinks to minimize the clock skew of the clock tree.

In step S416, during the step of comparing the path delay value on each inverter with the target value, if the path delay value on the inverter is greater than the target value, the design tool utilizes the current cell type and return to step S406 to compare the next inverter with the target value.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A method of balancing path delay of a clock tree for minimizing clock skew of the clock tree after performing clock tree synthesis (CTS) and routing procedures, wherein the clock tree comprises a root cell, a plurality of inverters, a plurality of sinks, and signal nets among the root cell, the inverters and the sinks, the method comprising the steps of:
establishing the clock tree;
calculating a plurality of path delay values from the root cell to each sink via some of the inverters, wherein the maximum one of the path delay values recorded on the sinks serves as a target value, respectively;
comparing the path delay value of each sink with the delay value of the adjacent sink from each sink to the root cell for recording the compared higher value on each inverter until the higher compared values are recorded, respectively, in the inverters and the root cell;
comparing the path delay value on each inverter with the target value to determine whether to change the cell type of the inverter from a current cell type to a new cell type by selecting the new cell type from a type database; and
updating the value recorded on the downstream inverters and the sinks in relation to the inverter based on the compared result between the path delay value and the target value so that the path delay values of the inverters approach to the target value for minimizing the clock skew of the clock tree.

2. The method of claim 1, wherein while comparing the path delay value on each inverter with the target value, the path delay values are compared with the target value from the root cell to the sinks.

3. The method of claim 1, wherein each cell delay of the downstream inverters and sinks maintains invariant during the step of comparing the path delay value on each inverter with the target value.

4. The method of claim 1, wherein the type database comprises a plurality of cell types and each cell type corresponds to different cell delay.

5. The method of claim 4, wherein an output loading corresponding to the cell type of the inverter is proportional to the cell delay for the path delay value.

6. The method of claim 1, during the step of comparing the path delay value on each inverter with the target value, if the path delay value on the inverter is less than the target value, further comprising a step of changing the cell type of the inverter from the current cell type to the new cell type.

7. The method of claim 6, after the step of changing the cell type of the inverter, further comprising a step of re-calculating the cell delay of the inverter having the new cell type.

8. The method of claim 7, after the step of re-calculating the cell delay of the inverter, further comprising a step of adding a difference value, between the new cell delay and the original cell delay of the inverter, to the path delay value of the inverter for updating the value recorded on the inverter.

9. The method of claim 7, further re-calculating the cell delay until the updated value recorded on the inverter is equal to or approximate to the target value.

10. The method of claim 7, further comprising a step of updating the path delay values recorded on the downstream inverters in relation to the inverter having the new cell type based on the difference value.

11. The method of claim 1, during the step of comparing the path delay value on each inverter with the target value, if the path delay value on the inverter is greater than the target value, further comprising utilizing the current cell type.

12. A method of balancing path delay of a clock tree for minimizing clock skew of the clock tree, wherein the clock tree comprises a root cell, a plurality of cells, a plurality of sinks, and signal nets among the root cell, the cells and the sinks, the method comprising the steps of:
calculating a plurality of path delay values from the root cell to each sink via some of the cells, wherein the maximum one of the path delay values recorded on the sinks serves as a target value, respectively;
comparing the path delay value of each sink with the delay value of the adjacent sink for recording the compared higher value on each cell until the higher compared values are recorded, respectively, in the cells and the root cell;
comparing the path delay value on each cell with the target value from the root cell to the sinks to determine whether to change the cell type of the cell from a current cell type to a new cell type by selecting the new cell type from a type database; and
updating the value recorded on the downstream cells and the sinks in relation to the cell based on the compared result between the path delay value and the target value so that the path delay values of the cells approach to the target value for minimizing the clock skew of the clock tree.

13. The method of claim 12, wherein each cell delay of the downstream cells and sinks maintains invariant during the step of comparing the path delay value on each cell with the target value.

14. The method of claim 12, wherein the type database comprises a plurality of cell types and each cell type corresponds to different cell delay.

15. The method of claim 12, during the step of comparing the path delay value on each cell with the target value, if the path delay value on the cell is less than the target value, further comprising a step of changing the cell type of the cell from the current cell type to the new cell type.

16. The method of claim 15, after the step of changing the cell type of the cell, further comprising a step of re-calculating the cell delay of the cell having the new cell type.

17. The method of claim 16, after the step of re-calculating the cell delay of the cell, further comprising a step of adding a difference value, between the new cell delay and the original cell delay of the cell, to the path delay value of the cell for updating the value recorded on the cell.

18. The method of claim 16, further repeatedly re-calculating the cell delay until the updated value recorded on the cell is equal to or approximate to the target value.

19. The method of claim 16, further comprising a step of updating the path delay values recorded on the downstream cells in relation to the cell having the new cell type based on the difference value.

20. The method of claim 12, during the step of comparing the path delay value on each cell with the target value, if the path delay value on the cell is greater than the target value, further comprising utilizing the current cell type.
